(19) United States
(12) Patent Application Publication
(10) Pub. No.: US 2010/0047652 A1
(43) Pub. Date: Feb. 25, 2010

(54) DIRECT METHANOL FUEL CELL AND CATHODE FOR DIRECT METHANOL FUEL CELL

(76) Inventors: Jungmin Song, Kawasaki-shi (JP); Taishi Fukazawa, Tokyo (JP); Yoshihiro Akasaka, Kawasaki-shi (JP); Minoru Hashimoto, Yokohama-shi (JP); Masato Akita, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/542,090

(22) Filed: Aug. 17, 2009

(30) Foreign Application Priority Data
Aug. 21, 2008 (JP) 2008-212905

(51) Int. Cl. H01M 4/86; H01M 4/00; H01M 8/10

(52) U.S. Cl. 429/30; 429/44; 429/42

(57) ABSTRACT

A cathode for a direct methanol fuel cell is provided. The cathode comprises a cathode catalyst layer includes a first carbon powder supporting a noble metal catalyst, a proton conductive polyelectrolyte at least partially covering a surface of the first carbon powder, and a second carbon powder having a water repellent material on a surface thereof. The cathode catalyst layer is accompanied with a porous structure satisfying following conditions.

40%≦(V₁/V₀)≦70%

wherein V₀ represents a volume of pores having a diameter ranging from 3 nm to 10 μm, and V₁ represents a volume of pores having a diameter ranging from 50 nm to 10 μm.

### CROSS-REFERENCE TO RELATED APPLICATIONS

This application is based upon and claims the benefit of priority from prior Japanese Patent Application No. 2008-212905, filed Aug. 21, 2008, the entire contents of which are incorporated herein by reference.

### BACKGROUND OF THE INVENTION

1. Field of the Invention

This invention relates to a direct methanol fuel cell (DMFC) and to a cathode for the direct methanol fuel cell.

2. Description of the Related Art

In this DMFC, electrical energy is produced by directly converting the chemical energy of a fuel into electrical energy through the electrochemical oxidation of a fuel such as methanol in the cell.

In order to enhance the output of the cell, this DMFC is required to be constructed so as to enable it to keep the balance between the supply of fuel and the move of the reaction product generated. JP-A 2001-283875 (KOKAI) describes that it is possible to create such a structure as described above by disposing a layer containing a water repellent material such as fluororesin, silicon resin, polyethylene, etc. in an anode or a cathode. Further, there is also known a solid polyelectrolyte film fuel cell having a structure which makes it possible to secure not only the gas permeability but also moisture retention at a gas diffusion electrode.

Since a lot of water is generated at the cathode catalyst layer as a result of the reaction at the electrode, the catalyst layer is required to be constructed in such a manner that the diffusion of the reaction gas is not obstructed. Conventionally, the improvement of the fugacity of water generated has been achieved by the inclusion of water-repellent particles in the cathode catalyst layer to make the cathode catalyst layer hardly wettable. However, although it is possible to make the cathode catalyst layer hardly wettable by the inclusion of water-repellent particles therein, there are many possibilities that the network of electrolyte may be collapsed.

It has been considered possible to inhibit the flooding by securing the diffusion supply path of fuel gas by the inclusion of the carbon powder whose surface has been treated to exhibit water-repellency. However, the diffusion/supply path of fuel gas may not be sufficiently secured. The reason is that the porous structure of the catalyst layer may be greatly influenced depending on the kind of carbon, on the quantity of water repellent carbon powder, and on the viscosity of a dispersion containing the carbon powder and a repellent material. Even if the amount of a repellent material to the weight of the catalyst layer is controlled, it is still difficult to sufficiently secure the diffusion/supply path of fuel gas. No one has succeeded as yet to obtain a DMFC having such a cathode catalyst layer that secures the fugacity of generated water sufficiently while retaining the network of electrolyte.

The porous structure of the catalyst layer can be classified into a pore (primary pore) which corresponds to a void formed between the primary particles and a large pore (secondary pore) which is formed between aggregates. The occupation ratio of the electrolyte in each of these two kinds of pores can be determined by the catalyst utilization ratio in the electrode or by the pore occupation ratio of the electrolyte. It is generally recognized that the primary pore contributes mainly as an electrolyte network and the secondary pore contributes as a network for the reaction gas. In order to secure more effective dispensability of the reaction gas, it is important to increase the porosity of the secondary pore which contributes to the dispensability of the reaction gas.

To confirm the performance of the cathode using a low air feeding quantity is an effective way to confirm the dispensability of the reaction gas. Accordingly, it is now desired to obtain a cathode for DMFC which exhibits a high performance even with a low feeding rate of air.

### BRIEF SUMMARY OF THE INVENTION

A cathode for a direct methanol fuel cell according to one aspect of the present invention comprises a cathode catalyst layer comprising:

a first carbon powder supporting a noble metal catalyst;

a proton conductive polyelectrolyte at least partially covering a surface of the first carbon powder; and

a second carbon powder having a water repellent material on a surface thereof;

wherein the cathode catalyst layer is accompanied with a porous structure satisfying following conditions;

40%≦(V₁/V₀)≦70%

wherein V₀ represents a volume of pores having a diameter ranging from 3 nm to 10 μm; and V₁ represents a volume of pores having a diameter ranging from 50 nm to 10 μm.

A cathode for a direct methanol fuel cell according to another aspect of the present invention comprises a cathode catalyst layer comprising carbon powder supporting a noble metal catalyst;

a proton conductive polyelectrolyte at least partially covering a surface of the carbon powder; and

a carbon material having a water repellent material on a surface thereof and incorporated into the cathode catalyst layer;

wherein:

an amount of the carbon material is 1-10% based on a total weight of the catalyst layer;

5 wt % or more of the carbon material is occupied by carbon fiber; and

the cathode catalyst layer is accompanied with a porous structure containing pores having a diameter ranging from 3 nm to 10 μm.

A direct methanol fuel cell according to one aspect of the present invention comprises an anode; the aforementioned cathode; and an electrolytic film sandwiched between the anode and the cathode.

### BRIEF DESCRIPTION OF THE SEVERAL VIEWS OF THE DRAWING

FIG. 1 is a cross-sectional view of the cell of DMFC according to one embodiment;

FIG. 2 is a diagram illustrating the cathode catalyst layer of DMFC according to one embodiment;

FIG. 3 is a diagram illustrating the cathode catalyst layer of DMFC according to another embodiment;

FIG. 4 is a graph illustrating an integrated volume of pores in the cathode catalyst layer; and

FIG. 5 is a graph illustrating the stability of cell voltage.

### DETAILED DESCRIPTION OF THE INVENTION

Next, embodiments will be explained in detail with reference to drawings. In these drawings, the same components will be identified by the same reference numbers thereby omitting the duplication of explanation. Further, these drawings are depicted schematically and hence the relationship between the thickness and the planar dimensions as well as the ratios in thickness among the layers may differ from those actually employed. Furthermore, the relationship between the dimensions as well as the ratio of components may differ from one another even among drawings.

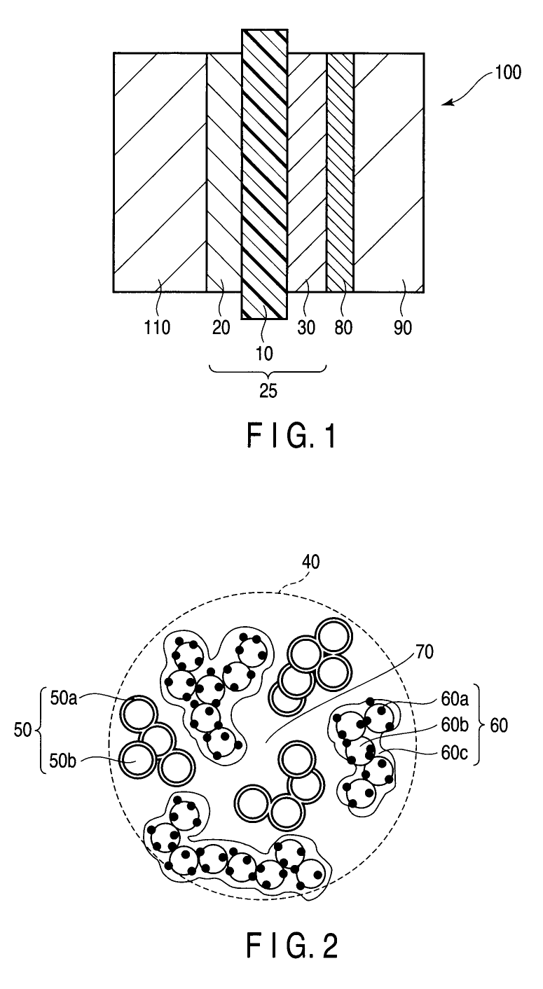

As shown in FIG. 1, in the cell 100 of the direct methanol fuel cell according to one embodiment, an electrolytic film 10 is sandwiched between an anode catalyst layer 20 and a cathode catalyst layer 30, thereby constituting a CCM (Catalyst Coated Membrane) 25. An anode MPL (densified water repellent layer)-attached GDL (Gas Diffusion Layer) 110 is disposed on the outside of the anode catalyst layer 20. A cathode MPL 80 and a cathode GDL 90 are successively disposed on the cathode catalyst layer 30.

A laminated body comprising the anode MPL-attached GDL 110, the anode catalyst layer 20, the electrolytic film 10, the cathode catalyst layer 30, the cathode MPL 80 and the cathode GDL 90 is referred to as a membrane electrode assembly (MEA).

The cathode GDL 90 and anode MPL-attached GDL 110 are generally constituted by a porous conductive material and enabled to function as a current collector. The anode MPL-attached GDL 110 acts to feed a fuel to the anode catalyst layer 20, and the cathode GDL 90 acts to feed an oxidizer gas to the cathode catalyst layer 30.

The anode catalyst layer 20 and the cathode catalyst layer 30 are generally constituted respectively by a porous layer comprising a catalytic active material, a conductive material and a proton conducting material. For example, these catalyst layers can be constituted by a porous layer containing a catalyst supported by a conductive material and a proton conducting material.

Incidentally, a combination of the catalyst layer with the GDL is referred to as an electrode. A combination of the anode catalyst layer 20 with the anode MPL-attached GDL 110 is referred to as an anode. A combination of the cathode catalyst layer 30 with the cathode MPL 80 and the cathode GDL 90 is referred to as a cathode.

On the occasion of operating the DMFC which is constructed as described above, an aqueous solution of methanol is supplied from a liquid fuel storage section (not shown) to the anode-side electrode. Air acting as an oxidizer is fed to the cathode catalyst layer 30. In the anode catalyst layer 20, a catalytic reaction represented by the following reaction formula (1) takes place. In the cathode catalyst layer 30, a catalytic reaction represented by the following reaction formula (2) takes place. In view of these reactions, the catalyst layer is also referred to as a reaction layer.

CH₃OH+H₂O→CO₂+6H⁺+6e⁻ (1)

6H⁺+(3/2)O₂+6e⁻→3H₂O (2)

In the anode catalyst layer 20, methanol reacts with water to generate carbon dioxide, protons and electrons. Protons pass through the electrolytic film 10 to reach the cathode. On the other hand, in the cathode catalyst layer 30, the electrons that have reached the cathode catalyst layer 30 after passing through an external circuit react with oxygen and protons, thereby generating water.

On this occasion, when the anode and the cathode are connected in advance with an external circuit, it is possible to extract electrical energy by the generated electrons. The water generated can be discharged from the cell through the cathode. On the other hand, the carbon dioxide has been generated at the anode diffuse in the fuel liquid phase provided that the liquid fuel is supplied directly to the cell and then the carbon dioxide is discharged from the system of fuel cell through a gas-permeating membrane which permits only the permeation of gas.

In order to obtain excellent cell properties in the fuel cell constructed as described above, it is required to smoothly supply a suitable quantity of fuel to each of the electrodes. Further, it is also required that the catalytic reaction in the electrodes is enabled to take place quickly at the three-phase interface among the catalytic active material, the proton conductive material and the fuel. Furthermore, in addition to the requirement to enable the electrons and protons to move smoothly, it is also required to quickly discharge the reaction products.

The electrolytic film 10 of the DMFC according to one embodiment can be manufactured, for example, by pre-treating a perfluorocarbon sulfonate film having a predetermined dimension with hydrogen peroxide and sulfuric acid. As this perfluorocarbon sulfonate film, it is possible to employ, for example, Nafion (trademark) 112 (Du pont Co. Ltd.). This perfluorocarbon sulfonate film is used by cutting it to have predetermined dimensions. The dimensions of the electrolytic film may be, for example, 10-100 mm in length and 10-100 mm in width.

The anode catalyst layer 20 is used mainly for the purpose of promoting the reaction between methanol and water to create protons, electrons and carbon dioxide. This anode catalyst layer 20 can be manufactured by a process wherein a material for the anode catalyst layer is coated on a PTFE sheet and then dried. With respect to examples of the anode catalyst, it is possible to employ carbon powder supporting a catalytic noble metal (supported catalyst) in addition to a Pt/Ru alloy catalyst which is not supported on carbon (PtRu Black HiSPEC6000; Johnson & Matthey Co., Ltd.). As the material for the anode catalyst layer, it can be prepared for example by a method wherein water is added to these catalysts and sufficiently agitated to obtain a mixed liquid, to which a proton conducting solution represented by perfluorocarbon sulfonate solution (Nafion (trademark) solution; Aldrich SE-29992 Nafion (trademark): 5 wt %; Du pont Co., Ltd.) and an organic solvent are added and dispersed therein to prepare the material for the anode catalyst layer.

With respect to the organic solvent, it is possible to employ for example 1-propanol, 2-propanol, ethylene glycol, ethanol, etc. These organic solvents may be used singly or in combination of two or more kinds thereof. The dispersion treatment can be performed using a commonly employed dispersing apparatus (such as a ball mill, a sand mill, a beads mill, a paint shaker, nanomizer, etc.).

As the fine catalyst powder, a Pt-containing alloy catalyst is employed in this embodiment. With respect to this Pt-containing alloy catalyst, it is possible to employ, though not limited thereto, PtRu alloys, PtRuSn, PtFe, etc. When the density of active site and the stability are taken into account, it is more preferable to employ the fine catalyst powder having an average particle diameter of 2-5 nm or so. The fine catalyst powder can be supported on carbon powder by any optional methods. For example, it is possible to employ a solid-phase reaction method, a solid phase-liquid phase reaction method, a liquid-phase method, a vapor-phase method, etc. With respect to the liquid-phase method, it is possible to employ an impregnation method, a precipitation method, a coprecipitation method, a colloidal precipitation method, or an ion-exchange method. Further, in addition to the carbon-supported catalyst (including carbon nano-horn or nano-tube), other kinds of supported catalysts may be employed.

The anode catalyst layer 20 that has been dried is preferably formulated to contain a catalyst at a loading amount of 1-10 mg/cm².

The cathode catalyst layer 30 is employed mainly for the purpose of promoting the reaction of protons, electrons and oxygen to create water. In the DMFC according to one embodiment, the cathode catalyst layer 30 is constituted by carbon powder supporting a noble metal catalyst thereon and at least partially covered by a proton conductive polyelectrolyte (this carbon powder is hereinafter referred to as an electrolyte-covered noble metal supporting carbon powder catalyst), and by carbon powder accompanied on the surface thereof with a water repellent material.

FIG. 2 shows schematically the construction of the cathode catalyst layer 30. The surface of carbon powder 50b is covered with a water repellent material 50a, thereby creating carbon powder 50 (second carbon powder) accompanied on the surface thereof with a water repellent material. On the other hand, carbon powder 60b is constructed such that a noble metal catalyst 60a is supported thereon, that the surface thereof is at least partially covered with a proton conductive polyelectrolyte 60c, thereby creating an electrolyte-covered noble metal supporting carbon powder catalyst 60. The carbon powder 50 accompanied on the surface thereof with a water repellent material, and the electrolyte-covered noble metal supporting carbon powder catalyst 60 can be respectively referred to as a primary particle. As these primary particles are aggregated, a single aggregate 40 is created. In this aggregate 40, pores 70 are created between these primary particles. These pores correspond respectively to a primary pore.

As examples of the carbon powder supporting a noble metal catalyst, it is possible to employ a Pt/C catalyst (HP 40-wt % Pt on Vulcan XC-72R; available from E-TEK Co., Ltd.) or TEC 10E70 TPM (Tanaka Kikinzoku Kogyo K.K.), etc. Although it is preferable to employ a Pt-containing noble metal catalyst as a material for the fine catalyst powder, it may not be limited to the Pt-containing noble metal catalyst. When the density of active site and the stability are taken into account, it is preferable to employ the fine catalyst powder having an average particle diameter of 2-5 nm or so.

The fine catalyst powder can be supported on carbon powder by any optional methods. For example, it is possible to employ a solid-phase reaction method, a solid phase-liquid phase reaction method, a liquid-phase method, a vapor-phase method, etc. With respect to the liquid-phase method, it is possible to employ an impregnation method, a precipitation method, a coprecipitation method, a colloidal precipitation method, or an ion-exchange method. Further, in addition to the carbon-supported catalyst (including carbon nano-horn and nano-tube), other kinds of supported catalysts may be employed. As the average particle diameter of the carbon powder to be used for supporting the fine catalyst powder, it is preferably confined to 20-80 nm or so.

With respect to examples of the proton conductive polyelectrolyte, it is possible to employ for example perfluorocarbon sulfonate solution (Nafion (trademark) solution; Aldrich SE-20092 Nafion (trademark): 5 wt %; Du pont Co., Ltd.), ion-exchange resins available from Dow Chemicals Co., Ltd, ionic copolymers (ionomers), etc.

Examples of the water repellent material include, for example, polytetrafluoroethylene (PTFE), tetrafluoroethylene-perfluoroalkyl vinylether copolymer (PFA), tetrafluoroethylene-hexafluoropropylene copolymer (FEP), polychlorotrifluoroethylene (PCTFE), poly(vinylidene fluoride) (PVDF), poly(vinyl fluoride) (PVF), tetrafluoroethylene-ethylene copolymer (ETFE), amorphous fluororesin, etc.

Examples of the carbon powder covered with a water repellent material include, for example, high-electroconductive carbon black (KETJEN BLACK), furnace black (Vulcan XC), and acetylene black. In order to maintain a suitable degree of specific surface area and pore capacity, the average particle diameter of the carbon powder is preferably limited to 20-80 nm or so. The average particle diameter of the carbon powder may be set to the diameter of crystallite that can be determined for example by the half band width of diffraction peak of a catalytic metal in the X-ray diffraction. Alternatively, the average particle diameter of the carbon powder may be determined from an average value in particle diameter of the catalytic metal that can be investigated by referring to a transmission electron micrograph.

In the manufacture of the cathode catalyst layer containing the aforementioned components, carbon powder is mixed with a water repellent material at first and then the resultant mixture is sintered at a predetermined temperature to obtain carbon powder having the water repellent material on its surface (a water repellent material-covered carbon powder). Although the sintering temperature in this case may be suitably determined taking the kinds of the water repellent material into consideration, it generally ranges from 150-360° C. After the sintering of the carbon powder, it is ground to small sizes of around 20-100 nm by a mortar, etc.

As long as the entire surface of the carbon powder is completely covered by a water repellent material, the effects of the water repellent material can be sufficiently exhibited. However, the surface of the carbon powder may not be completely covered by a water repellent material. Namely, as long as the effects of the water repellent material are not substantially diminished, the surface of the carbon powder may be partially exposed.

The water repellent-covered carbon powder that has been ground, the carbon powder supporting a noble metal catalyst, and the proton conductive polyelectrolyte are then mixed together and dispersed in an organic solvent to prepare a material for the cathode catalyst layer.

Examples of the organic solvent include 1-propanol, 2-propanol, ethylene glycol, ethanol, etc. These organic solvents may be employed singly or in combination of two or more kinds. The dispersion treatment may be performed using a commonly employed dispersing apparatus (such as a ball mill, a sand mill, a beads mill, a paint shaker, nanomizer, etc.).

The material for the cathode catalyst layer is then coated on a PTFE sheet and dried to create a cathode catalyst layer. The cathode catalyst layer that has been dried is preferably formulated to contain a catalyst at a loading amount of about 1-5 mg/cm².

In this embodiment, the cathode catalyst layer 30 is formed so as to include pores each having a diameter ranging from 3 nm to 10 μm, 40-70% of the pore based on a total volume of the pores being occupied by pores having a diameter ranging from 50 nm to 10 μm. In the other word, the cathode catalyst layer is accompanied with a porous structure satisfying following conditions.

40%≦(V₁/V₀)≦70%

wherein V₀ represents a volume of pores having a diameter ranging from 3 nm to 10 μm; and V₁ represents a volume of pores having a diameter ranging from 50 nm to 10 μm.

Since these pores having a diameter ranging from 50 nm to 10 μm are served as a gas network, it would be impossible to realize such an effect if the volume of the pores is less than 40% based on the total volume thereof. On the other hand, if the volume of the pores is excessive, it would be impossible to realize a preferable pore distribution and hence the upper limit of this volume is confined to 70% based on the total volume thereof.

These pores having a diameter ranging from 50 nm to 10 μm and formed in the cathode catalyst layer is preferably constructed such that 50-80% of the pores based on a total volume of the pores having a diameter ranging from 50 nm to 10 μm is constituted by carbon powder having a water repellent material on the surface thereof. Due to the effects of the carbon powder having a water repellent material on the surface thereof, it is possible to enhance the dispersion of the reaction gas.

The ratio of “pores constituted by carbon powder having a water repellent material on the surface thereof” can be determined by the following process. First of all, a catalyst formed of only the electrolyte-covered noble metal supporting carbon powder catalyst 60 is prepared as a reference catalyst. The volume of the pores of this reference catalyst having a diameter within the range of x1 to x2 (for example, x1=50 nm, x2=10 μm) is measured, designating this measured value as “measured value A”. Then, the carbon powder 50 accompanied on the surface thereof with a water repellent material is mixed with the electrolyte-covered noble metal supporting carbon powder catalyst 60 to prepare a cathode catalyst. The volume of the pores of this cathode catalyst having a diameter within the range of x1 to x2 is measured, designating this measured value as “measured value B”.

The pores which corresponds to the difference between this couple of measured values (ΔP=B−A) is herein referred to as the “pores constituted by carbon powder having a water repellent material on the surface thereof”.

Therefore, when the value of R represented by (R=((B−A)/B)×100) is confined to the range of 50 to 80%, it will satisfy the conditions of: “pores having a diameter within the range of x1-x2 and formed in the cathode catalyst layer is constructed such that 50-80% of the pores based on a total volume of the pores having a diameter within the range of x1-x2 is constituted by carbon powder having a water repellent material on the surface thereof”.

Further, the carbon powder accompanying a water repellent material on its surface is preferably contained in the cathode catalyst layer at an amount of 1-10% based on a total weight of the cathode catalyst layer. If the content of this carbon powder is too little, it would be impossible to expect the effects thereof. If the content of this carbon powder becomes excessive, problems such as the cut-off of the network of proton or the deterioration of electron conductivity by the insulating property of a water repellent material may be caused to occur. Accordingly, the content of the water repellent material is preferably confined to 1-5% based on the total weight of the cathode catalyst layer.

These anode catalyst layer and cathode catalyst layer are respectively mounted on a PTFE sheet and, under this condition, cut into a piece having a predetermined dimension. The anode catalyst layer 20 and the cathode catalyst layer 30 thus cut off are respectively placed to contact with and bonded to the electrolytic film 10 by thermocompression. The dimensions of the resultant body may be 10-100 mm in length and 10-100 mm in width for example. Thereafter, the PTFE sheet is peeled off to create a laminated body comprising the electrolytic film 10 which is held between the anode catalyst layer 20 and the cathode catalyst layer 30. The catalyst coated membrane (CCM) 25 is constituted by this laminated body obtained in this manner.

This anode catalyst layer 20 of CCM 25 is laminated thereon with an anode MPL-attached GDL 110. The anode MPL in the anode MPL-attached GDL 110 is generally formed by a slurry containing a water repellent material and a conductive material. Preferable examples of the water repellent material are water repellent organic synthetic resins such as PTFE, PFA, FEP, PCTFE, PVDF, PVF or ETFE. Preferable examples of the conductive material include conductive carbon such as furnace black, acetylene black or graphitized black.

As the base material for the anode GDL, it is possible to employ any kinds of porous sheet-like supporting body containing carbon as a base material. Generally, this base material is formed of a porous base material containing fiber. With respect to the fiber, carbon fiber which is electrically conductive and anti-corrosive can be suitably employed. However, the fiber may not be limited to such a carbon fiber. In order to inhibit the methanol cross-over, the thickness of the anode GDL is preferably not less than 200 μm, more preferably not less than 250 μm. In order to retain the basic characteristics of the fuel cell in excellent conditions, the thickness of the anode GDL is preferably 500 μm or less, more preferably 400 μm or less.

On the outside of the anode MPL-attached GDL 110, there is disposed a fuel supply means (not shown) for supplying a liquid fuel (methanol) to the anode MPL-attached GDL 110. The concentration of the methanol fuel is preferably confined to 0.5-3 M, more preferably 0.5-2 M.

On the other hand, the cathode catalyst layer 30 of CCM 25 is laminated thereon with a cathode MPL 80 and a cathode GDL 90. The cathode MPL 80 can be constituted by electron-conductive carbon and the aforementioned water repellent organic resin. The cathode GDL 90 can be constituted by carbon paper or carbon fiber. On the outside of the cathode GDL 90, there is disposed an oxidizing gas supply means (not shown) for supplying air as an oxidizing gas to the cathode GDL 90.

The cathode catalyst layer to be included in the DMFC according to this embodiment is constructed such that it comprises not only carbon powder supporting a noble metal catalyst therein and having a surface which is at least partially covered with a proton conductive polyelectrolyte but also water repellent material-covered carbon powder. This cathode catalyst layer is further accompanied with pores each having a diameter ranging from 3 nm to 10 μm, wherein 40-70% of the pore based on a total volume of the pore is occupied by pores having a diameter ranging from 50 nm to 10 μm.

Since the cathode catalyst layer satisfies all of these conditions, it is now possible to manufacture a cathode catalyst layer which makes it possible to secure a sufficient gas network and a high proton conductivity. As a result, it is now possible to obtain a DMFC of high output, which makes it possible to enhance the utilization factor and to secure a sufficient cell output.

Next, the DMFC according to another embodiment will be explained. This DMFC is provided with a cathode comprising a cathode catalyst layer providing with following conditions. This cathode catalyst layer comprises carbon powder supporting a noble metal catalyst; a proton conductive polyelectrolyte at least partially covering a surface of the carbon powder; and a carbon material having a water repellent material on a surface thereof and incorporated into the cathode catalyst layer. The amount of the carbon material is 1-10% based on a total weight of the catalyst layer. 5 wt % or more of the carbon material is occupied by carbon fiber. The cathode catalyst layer is accompanied with a porous structure containing pores having a diameter ranging from 3 nm to 10 μm. Namely, the cathode is constituted by this cathode for the DMFC according to said another embodiment.

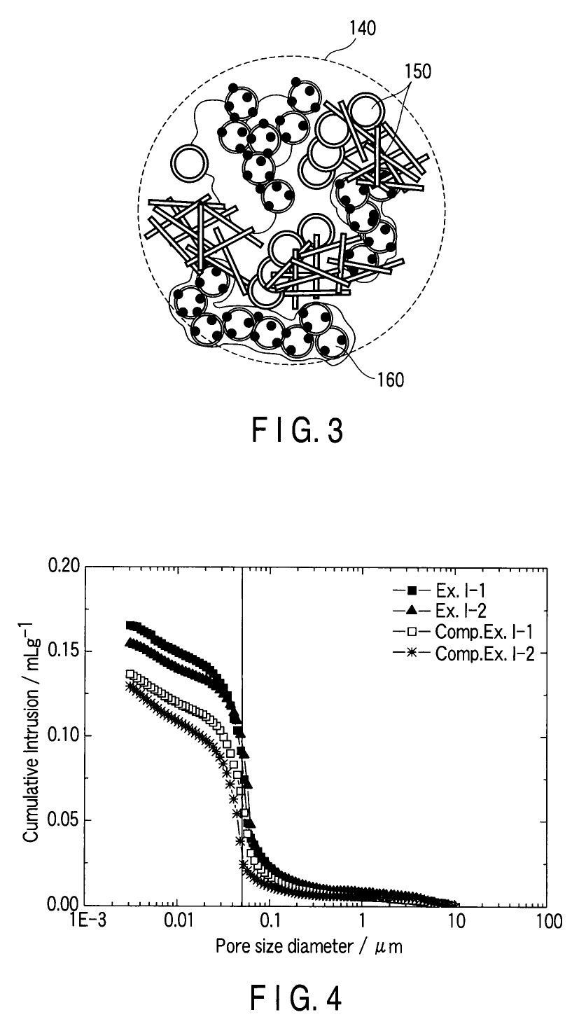

FIG. 3 schematically shows the construction of this cathode catalyst layer. A single aggregate 140 is constituted by carbon material 150 having a water repellent material on its surface, and a catalyst 160 covered with an electrolyte. The carbon material 150 covered with a water repellent material is constituted by carbon powder and a predetermined quantity of carbon fiber.

As examples of the carbon powder supporting a noble metal catalyst, it is possible to employ a Pt/C catalyst (HP 40-wt % Pt on Vulcan XC-72R; available from E-TEK Co., Ltd.) or TEC 10E70 TP (Tanaka Kikinzoku Kogyo K.K.), etc. Although it is preferable to employ a Pt-containing noble metal catalyst as a material for the fine catalyst powder, it may not be limited to the Pt-containing noble metal catalyst. When the density of active site and the stability are taken into account, it is more preferable to employ the fine catalyst powder having an average particle diameter of 2-5 nm or so.

The fine catalyst powder can be supported on carbon powder by any optional methods. For example, it is possible to employ a solid-phase reaction method, a solid phase-liquid phase reaction method, a liquid-phase method, a vapor-phase method, etc. With respect to the liquid-phase method, it is possible to employ an impregnation method, a precipitation method, a coprecipitation method, a colloidal precipitation method, or an ion-exchange method. Further, in addition to the carbon-supported catalyst (including carbon nano-horn and nano-tube), other kinds of supported catalysts may be employed.

As the average particle diameter of the carbon powder to be used for supporting the fine catalyst powder, it is preferably confined to 20-80 nm or so.

With respect to examples of the proton conductive polyelectrolyte, it is possible to employ for example perfluorocarbon sulfonate solution (Nafion (trademark) solution; Aldrich SE-29992 Nafion (trademark): 5 wt %; Du pont Co., Ltd.), ion-exchange resins available from Dow Chemicals Co., Ltd, ionic copolymers (ionomers), etc.

Examples of the water repellent material include, for example, PTFE, PFA, FEP, PCTFE, PVDF, PVF, ETFE, amorphous fluororesin, etc.

Examples of the carbon powder covered with such a water repellent material include, for example, KETJEN BLACK, Vulcan XC, and acetylene black. In order to maintain a suitable degree of specific surface area and pore capacity, the average particle diameter of the carbon powder is preferably limited to 20-80 nm or so. The average particle diameter of the carbon powder may be set to the diameter of crystallite that can be determined for example by the half band width of diffraction peak of a catalytic metal in the X-ray diffraction. Alternatively, the average particle diameter of the carbon powder may be determined from an average value in particle diameter of the catalytic metal that can be investigated by referring to a transmission electron micrograph.

On the other hand, the carbon fiber is preferably selected from those having an average diameter ranging from 50 nm to 1 μm and a specific surface area of not less than 150 m²/g. The average diameter of the fiber may be set to the diameter of crystallite that can be determined for example by the half band width of diffraction peak of a catalytic metal in the X-ray diffraction. Alternatively, the average particle diameter of the fiber may be determined from an average value in particle diameter of the catalytic metal that can be investigated by referring to a transmission electron micrograph. The specific surface area of the carbon fiber can be determined for example by the BET method. Incidentally, this combination of the carbon powder and the carbon fiber is herein referred to as a carbon material.

By using suitable carbon fiber, it is possible to obtain a high output of DMFC at a low air feeding quantity. The present inventors have assumed the reasons for this as follows. Namely, the progress of electrode reaction has been contributed not only by the structure of pores but also by the compatibility between the supported catalyst and other factors such as air, water, fuel that has been permeated, and the proton conductive material, by the diffusion of air and by the discharge of water. Incidentally, the carbon nanofiber can be variously classified by the manufacturing method, the structure or the surface conditions thereof. For example, from the aspect of structure, it can be classified into ones wherein the C-plane of graphite crystal is oriented in the longitudinal direction of fiber (so-called carbon nanotube structure), and ones wherein the C-plane of graphite crystal is oriented at an angle of 30° to 90° relative to the longitudinal direction of fiber (so-called Herringbone structure or Platelet structure).

In this embodiment, it has been made possible to manufacture an optimum catalyst layer by a carbon nanofiber carrier having the Herringbone structure or Platelet structure, an average diameter ranging from 50 to 400 nm, and a specific surface area of not less than 150 m²/g. When the diameter, characteristics and structure of the carbon fiber do not meet the aforementioned conditions, it may not be possible to obtain a stable and high cell output in the fuel cell. Furthermore, the deterioration of fuel cell characteristics may be brought about at a low air feeding quantity. Namely, it is assumed that the diffusion of air as well as the discharge of water may be deteriorated by the lowering of restraint against the bad influences due to the cross-over or the failure of obtaining a suitable pore distribution.

In this embodiment, the content of the carbon fiber is regulated to 5% or more based on a total weight of the carbon materials. It has been found out by the present inventors that when the content of the carbon fiber is less than 5 wt %, the effects by the addition of carbon fiber may become insufficient. On the other hand, due to the possibilities of failure to achieve a suitable pore distribution, it is preferable to confine the content of the carbon fiber to around 50 wt % based on a total weight of the carbon materials.

The carbon material accompanying a water repellent material on its surface is contained in the cathode catalyst layer at a content of 1-10% based on a total weight of the cathode catalyst layer. If the content of this carbon material is less than 1 wt %, it would be impossible to expect the effects thereof. On the other hand, if the content of this carbon material is more than 10 wt %, problems such as the cut-off of the network of proton or the deterioration of electron conductivity by the insulating property of a water repellent material may be caused to occur. The content of the water repellent material is preferably confined to 1-5% based on the total weight of the cathode catalyst layer.

In the manufacture of the cathode catalyst layer containing the aforementioned components, carbon powder is at first mixed with carbon fiber at a predetermined weight ratio to prepare a carbon material. Then the carbon material and a water repellent material is mixed to obtain a mixture, which is then sintered at a predetermined temperature to obtain carbon material having the water repellent material on its surface (a water repellent material-covered carbon material). Although the sintering temperature in this case may be suitably determined taking the kinds of the water repellent material into consideration, it generally ranges from 150-360° C. or so. After sintering the carbon material, it is ground to small sizes of around 20-100 nm by a mortar, etc.

As long as the entire surface of the carbon material is completely covered by a water repellent material, the effects of the water repellent material can be sufficiently exhibited. However, the surface of the carbon material may not be completely covered by a water repellent material. Namely, as long as the effects of the water repellent material are not substantially diminished, the surface of the carbon material may be partially exposed.

The ground water repellent material-covered carbon material, the carbon powder supporting a noble metal catalyst, and the proton conductive polyelectrolyte are then mixed together with an organic solvent and dispersed to prepare a material for the cathode catalyst layer.

With respect to the organic solvent, it is possible to employ for example 1-propanol, 2-propanol, ethylene glycol, ethanol, etc. These organic solvents may be used singly or in combination of two or more kinds thereof. The dispersion treatment can be performed using a commonly employed dispersing apparatus (such as a ball mill, a sand mill, a beads mill, a paint shaker, nanomizer, etc.).

The material for the cathode catalyst layer is then coated on a PTFE sheet and dried to create a cathode catalyst layer. The cathode catalyst layer that has been dried is preferably formulated to contain a catalyst at a loading amount of about 1-5 mg/cm².

In this embodiment, the cathode catalyst layer 30 is formed so as to include pores each having a diameter ranging from 3 nm to 10 μm, 50-90% of the pore based on a total volume of the pores being occupied by pores having a diameter ranging from 50 nm to 10 μm. In the other word, the cathode catalyst layer preferably has a porous structure satisfying the following conditions.

50%≦(V₁/V₀)≦90%

wherein V₀ represents a volume of pores having a diameter ranging from 3 nm to 10 μm; and V₁ represents a volume of pores having a diameter ranging from 50 nm to 10 μm.

As described above, since these pores having a diameter ranging from 50 nm to 10 μm constitute a pore region corresponding to a secondary pore serving as a gas network, the existence of these pores is demanded for the purpose of further enhancing the dispensability of reaction gas. If the volume ratio of the pores is less than 50%, it would be impossible to obtain sufficient effects. Meanwhile, in order to secure a sufficient surface area of the reaction region, i.e., a sufficient pore volume of the primary pore, the upper limit of the ratio of pores having a diameter ranging from 50 nm to 10 μm is preferably confined to 90%.

These pores having a diameter ranging from 50 nm to 10 μm and formed in the cathode catalyst layer is preferably constructed such that 50-80% of the pores based on a total volume of the pores having a diameter ranging from 50 nm to 10 μm is constituted by carbon powder having a water repellent material on the surface thereof. Due to the effects of the carbon powder having a water repellent material on the surface thereof, it is possible to enhance the dispersion of the reaction gas.

Incidentally, with respect to the determination of “pores constituted by carbon powder having a water repellent material on the surface thereof” and the determination of “pores having a diameter of 50 nm to 10 μm and formed in the cathode catalyst layer is constructed such that 50-80% of the pores based on a total volume of the pores having a diameter of 50 nm to 10 μm is constituted by carbon powder having a water repellent material on the surface thereof”, they are the same as explained above.

The cathode catalyst layer according to this embodiment is assembled together with other components such as the aforementioned electrolytic film and anode catalyst layer, thereby manufacturing the DMFC as shown in FIG. 1.

As described above, the cathode catalyst layer to be included in the DMFC according to this embodiment is constructed such that it comprises not only carbon powder supporting a noble metal catalyst thereon and having a surface which is at least partially covered with a proton conductive polyelectrolyte but also water repellent material-covered carbon material. This cathode catalyst layer is further accompanied with pores each having a diameter ranging from 3 nm to 10 μm. The content of the water repellent material-covered carbon material is confined to the range of 1-10%, wherein not less than 5 wt % of the carbon material is constituted by carbon fiber and the balance is constituted by carbon powder.

Since the cathode catalyst layer according to this embodiment is constructed to satisfy all of the aforementioned conditions, it is excellent not only in the dispensability of air and in water flooding. The DMFC which is provided with this cathode catalyst layer is enabled to inhibit the bad influence to be brought about by the cross-over of an aqueous methanol fuel, thereby making it possible to realize excellent fuel cell characteristics even at a low air feeding quantity.

Next, embodiments of the present invention will be explained with reference to examples.

### EXAMPLE I

This example explains the manufacture of a DMFC which is provided with a cathode comprising a cathode catalyst layer. This cathode catalyst layer is constructed such that it comprises carbon powder supporting a noble metal catalyst and having a surface which is at least partially covered with proton conductive polyelectrolyte; and water repellent material-covered carbon powder.

### EXAMPLE I-1

A Pt/C catalyst (HP 40-wt % Pt on Vulcan XC-72R; available from E-TEK Co., Ltd.) was employed as noble metal catalyst-supporting carbon powder and a solution of perfluorocarbon sulfonate (Nafion (trademark) solution, Aldich SE-20092, Nafion (trademark) 5 wt %; Du pont Co. Ltd.) was employed as a proton conductive polyelectrolyte.

The water repellent material-covered carbon powder was prepared according to the following procedures. As the carbon powder, acetylene black (Denka Black (powdery product); Denki Kagaku Kogyo Kabusiki Kaisha) was employed. As the water repellent material, amorphous fluororesin (a water repellent dispersion; Asahi Glass Co., Ltd.) was employed. The carbon powder was mixed with the water repellent material at a weight ratio of 1:1 and the resultant mixture was sintered in an electric furnace at a temperature of 180° C. The sintered material was then ground to obtain the water repellent material-covered carbon powder.

The water repellent material-covered carbon powder, the noble metal catalyst-supporting carbon powder and the proton conductive polyelectrolyte were mixed with each other to prepare a slurry for forming a material for the cathode catalyst layer. The slurry thus obtained was coated on a PTFE sheet and dried to manufacture the cathode catalyst layer.

### EXAMPLE I-2

Water repellent material-covered carbon powder was prepared according to the same procedures as described in Example I-1 except that high-conductive carbon black (KETJEN BLACK EC300J) was employed as the carbon powder to be covered with the water repellent material.

The cathode catalyst layer was manufactured according to the same procedures as described in Example I-1 except that the water repellent-covered carbon powder thus obtained was used.

### COMPARATIVE EXAMPLE I-1

The cathode catalyst layer was manufactured according to the same procedures as described in Example I-1 except that the water repellent-covered carbon powder was replaced with acetylene black (Denka Black (powdery product); Denki Kagaku Kogyo Kabusiki Kaisha).

### COMPARATIVE EXAMPLE I-2

The cathode catalyst layer was manufactured according to the same procedures as described in Example I-1 except that the water repellent-covered carbon powder was not used at all.

The loading amount of Pt in the cathode catalyst layer after drying was 6 mg/cm² in all of these Examples and Comparative Examples.

With respect to these cathode catalyst layers of these Examples and Comparative Examples, the construction of pores thereof was measured by a mercury intrusion technique. The graph of FIG. 4 illustrates cumulative pore volumes in the region of pores having a pore diameter of not more than 10 μm, which were obtained in the mercury intrusion method. The ratio of pore volume in the 50 nm-10 μm region relative to the entire volume of pores having a pore diameter of 3 nm-10 μm was calculated, the results being summarized in the following Table 1.

TABLE 1

| | | | Comp. | Comp. |
|---|---|---|---|---|
| | Ex. I-1 | Ex. I-2 | Ex. I-1 | Ex. I-2 |
| Pore volume | 57.6 | 45.1 | 39.3 | 18.9 |
| ratio (%) | | | | |

As shown in FIG. 4, the cathode catalyst layer of every Examples was found higher in cumulative pore volume as compared with Comparative Examples I-1 where a water repellent material was not included and also with Comparative Examples I-2 where the water repellent material-covered carbon powder was not employed. With respect to the ratio of the pores falling within the 50 nm-10 μm region, while the ratio in the case of the cathode catalyst layer of these Examples was 45.1% or more, the ratio in the example where a water repellent material was not included was at most 39.3% as clearly seen from the results shown in above Table 1.

Then, a DMFC was manufactured by each of the cathode catalyst layers of Examples and Comparative Examples. First of all, Nafion (trademark) 112 was prepared and cut out to create a piece of sheet having dimensions 40 mm in length and 50 mm in width. Based on the specification “G. Q. Lu, et al., Electrochimica Acta 49 (2004), pp. 821-828”, Nafion (trademark) 112 was subjected to a pre-treatment using hydrogen peroxide and sulfuric acid to manufacture an electrolytic film 10.

A Pt/Ru alloy catalyst (Pt/Ru Black HiSPEC 6000; available from Johnson & Matthey Co., Ltd.) and a perfluorocarbon sulfonate solution (Nafion (trademark) solution Aldrich SE-29992 Nafion (trademark): 5 wt %; Du pont Co., Ltd.) were mixed and dispersed with each other to prepare a material for the anode catalyst layer. This material then coated on a PTFE sheet and dried to manufacture an anode catalyst layer. The amount of the loading of the Pt/Ru in the dried anode catalyst layer was about 6 mg/cm².

The anode catalyst layer and the cathode catalyst layer were respectively mounted on a PTFE sheet and, under this condition, cut into a piece having a length of 30 mm and a width of 40 mm. The anode catalyst layer 20 and the cathode catalyst layer 30 thus cut off were respectively placed to contact with and bonded to the electrolytic film 10 by thermocompression under the conditions of 125° C. and 10 kg/cm². Thereafter, the PTFE sheet was peeled off to obtain the CCM 25 constituted by a laminated body comprising the electrolytic film 10 which was held between the anode catalyst layer 20 and the cathode catalyst layer 30. The thickness of the CCM 25 was about 90 μm. The thickness of the anode catalyst layer 20 and of the cathode catalyst layer 30 was about 30 μm, respectively.

Then, a fuel control layer (not shown) and the anode MPL-attached GDL 110 were successively superimposed on the anode catalyst layer 20 of the CCM 25. As a material for the anode MPL-attached GDL 110, TGPH-120, 30 wt % Wetproofed; available from E-TEK Co., Ltd. (i.e., carbon paper TGPH-120 (Toray Industries, Ltd.) which was water repellent-finished by PTFE about 30 wt % in concentration) was employed. Further, on this anode MPL-attached GDL 110 was disposed a fuel supply means (not shown) for supplying a fuel to this anode MPL-attached GDL 110.

Then, the cathode MPL 80 and the cathode GDL 90 were successively superimposed on the cathode catalyst layer 30 of the CCM 25. In this case, the MPL-attached cathode GDL was constituted by Elat GDL LT-2500-W (360 μm in thickness) (available from E-TEK Co., Ltd.). On this MPL-attached cathode GDL was disposed an oxidizing gas supply means (not shown) for supplying air as an oxidizing gas to the cathode GDL 90, thereby manufacturing the DMFC constructed as shown in FIG. 1.

The DMFC thus obtained was subjected to an electricity generation test. By fuel supply means, a fuel (aqueous methanol fuel) was supplied to the anode GDL at a concentration of 1.4 M and at a fuel supply rate of 0.7 cc/min. Further, by oxidizer supply means, air (oxidizer), 20.5% in oxygen concentration and 30% in humidity, was supplied from the cathode GDL at an oxygen supply rate of 35 cc/min, thereby actuating the fuel cell and assessing the cell characteristics such as the output voltage thereof. The conditions described above are ones wherein water is liable to retain in the DMFC.

On this occasion, the temperature to be measured by temperature sensors (not shown) installed at the fuel supply means and at the oxidizer supply means was regulated to 60° C. by a temperature controller (not shown). The preliminary heating of air and fuel was not performed.

Each of the DMFCs was operated under the aforementioned conditions, thus obtaining the results regarding the voltage characteristics at 0.15 A/cm² as summarized in the following Table 2.

TABLE 2

| | | | Comp. | Comp. |
|---|---|---|---|---|
| | Ex. I-1 | Ex. I-2 | Ex. I-1 | Ex. I-2 |
| Cell voltage | 0.42 | 0.41 | 0.38 | 0.39 |
| (V) | | | | |

As shown in above Table 2, the output voltage at 0.15 A/cm² was 0.39 V at most in the case of the DMFCs of Comparative Examples. Whereas, in the case of the DMFCs of Examples, it was possible to obtain an output of not less than 0.41 V. Thus, the DMFCs of Examples were found to indicate higher voltage characteristics as compared with those of Comparative Examples, thereby confirming the improvement of dispensability of oxygen in the cathode catalyst layer.

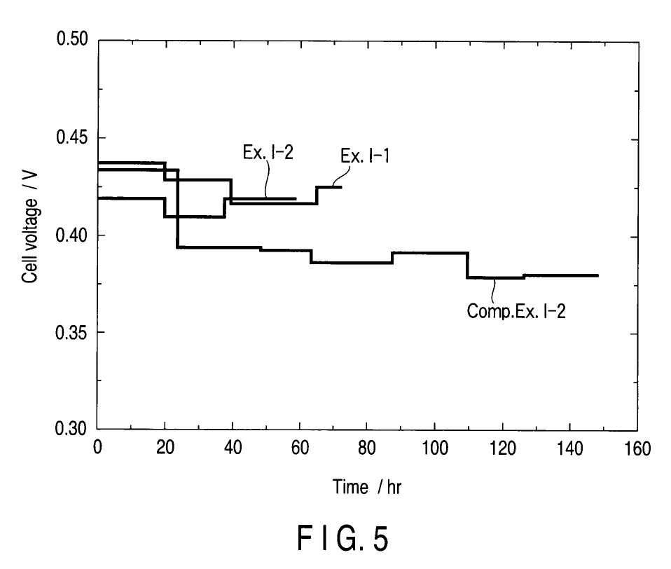

Air (oxidizer) was supplied to each of the DMFCs at a flow rate of 35 cc/min to investigate the stability of the output voltage at 0.15 A/cm². The graph of FIG. 5 shows averaged cell voltages which were measured during a time period of 20 hours.

As shown in FIG. 5, in the case of the DMFCs of Examples, although a fluctuation falling within the range of 0.012 V was recognized, it was confirmed possible to keep a stable and high cell voltage without accompanying the deterioration of cell voltage. By contrast, in the case of the DMFCs of Comparative Examples, the output voltage was lowered 20 hours later by 0.040 V or more, thus indicating that the DMFCs of Comparative Examples were incapable of obtaining a stable output voltage.

### EXAMPLE II

This example explains the manufacture of a cathode catalyst layer comprising carbon powder supporting a noble metal catalyst and having a surface which is at least partially covered with a proton conductive polyelectrolyte, and 1-10 wt %, based on a total weight of the cathode catalyst layer, of water repellent material-covered carbon materials (powder and fiber). Furthermore, by the cathode catalyst layer thus obtained, a DMFC was manufactured to investigate the characteristics thereof.

### EXAMPLE II-1

A Pt/C catalyst (HP 40-wt % Pt on Vulcan XC-72R; available from E-TEK Co., Ltd.) was employed as noble metal catalyst-supporting carbon powder and a solution of perfluorocarbon sulfonate (Nafion (trademark) solution, Aldich SE-20092, Nafion (trademark) 5 wt %; Du pont Co. Ltd.) was employed as a proton conductive polyelectrolyte.

The water repellent material-covered carbon materials were prepared according to the following procedures. The carbon materials comprise powder and fiber. As the carbon powder, acetylene black (Denka Black (powdery product); Denki Kagaku Kogyo Kabusiki Kaisha) was employed. As the carbon fiber, fibrous material having an average diameter of 200 nm and a specific surface area of about 250 m²/g was employed. The carbon fiber was mixed with the carbon powder at a weight ratio of 3:7 to obtain a carbon material. Then, a water repellent material was mixed with this carbon material at a weight ratio of 1:1. The resultant mixture was sintered in an electric furnace at a temperature of 180° C. The sintered material was then ground to obtain the water repellent material-covered carbon material.

The water repellent material-covered carbon material, the noble metal catalyst-supporting carbon powder and the proton conductive polyelectrolyte were mixed with each other to prepare a catalytic slurry. The slurry thus obtained was coated on a PTFE sheet and dried to manufacture the cathode catalyst layer of Example II-1. The content of the water repellent material-covered carbon material was 5% based on a total weight of the carbon catalyst layer.

As shown in the following Table 3, conditions such as the weight ratio between the carbon fiber and the carbon powder was variously changed to manufacture cathode catalyst layers of Examples II-2 to II-7 and Comparative Examples II-1 to II-3.

TABLE 3

| | | | Content (wt %) |
|---|---|---|---|
| | Carbon fiber:carbon | Water | of water |
| | powder | repellent | repellent- |
| | (weight ratio) | material | covered carbon |
| Ex. II-1 | 30:70 | Existed | 5 |
| Ex. II-2 | 100:0 | Existed | 6 |
| Ex. II-3 | 50:50 | Existed | 5 |
| Ex. II-4 | 10:90 | Existed | 5 |
| Ex. II-5 | 20:80 | Existed | 5 |
| Ex. II-6 | 40:60 | Existed | 6 |
| Ex. II-7 | 5:95 | Existed | 5 |
| Comp. Ex. II-1 | 30:70 | Not existed | 0 |
| Comp. Ex. II-2 | 30:70 | Existed | 15 |
| Comp. Ex. II-3 | 30:70 | Existed | 0.5 |

With respect to these cathode catalyst layers of these Examples and Comparative Examples, the construction of pores thereof was measured by mercury intrusion technique. The ratio of pore volume in the 50 nm-10 μm region relative to the entire volume of pores having a pore diameter of 3 nm-10 μm was calculated. The results are summarized in the following FIG. 4 together with the ratio of pores of the water repellent-covered carbon.

TABLE 4

| | | Pore ratio (%) |
|---|---|---|
| | 50 nm-10 μm | of water |
| | pore volume | repellent- |
| | ratio (%) | covered carbon |
| Ex. II-1 | 68 | 60 |
| Ex. II-2 | 80 | 65 |
| Ex. II-3 | 72 | 60 |
| Ex. II-4 | 58 | 65 |
| Ex. II-5 | 62 | 60 |
| Ex. II-6 | 67 | 58 |
| Ex. II-7 | 55 | 65 |
| Comp. Ex. II-1 | 48 | 0 |
| Comp. Ex. II-2 | 67 | 75 |
| Comp. Ex. II-3 | 60 | 58 |

Then, a DMFC was manufactured by each of the cathode catalyst layers of Examples and Comparative Examples. First of all, Nafion (trademark) 112 was prepared and cut out to create a piece of sheet having dimensions 40 mm in length and 50 mm in width. Based on the specification “G. Q. Lu, et al., Electrochimica Acta 49 (2004), pp. 821-828”, the Nafion (trademark) 112 was subjected to a pre-treatment using hydrogen peroxide and sulfuric acid to manufacture an electrolytic film 10.

A Pt/Ru alloy catalyst (Pt/Ru Black HiSPEC 6000; available from Johnson & Matthey Co., Ltd.) and a perfluorocarbon sulfonate solution (Nafion (trademark) solution Aldrich SE-29992 Nafion (trademark): 5 wt %; Du pont Co., Ltd.) were mixed and dispersed with each other to prepare a material for the anode catalyst layer. This material then coated on a PTFE sheet and dried to manufacture an anode catalyst layer. The amount of the loading of the Pt/Ru in the dried anode catalyst layer was about 6 mg/cm².

The anode catalyst layer and the cathode catalyst layer were respectively mounted on a PTFE sheet and, under this condition, cut into a piece having a length of 30 mm and a width of 40 mm. The anode catalyst layer 20 and the cathode catalyst layer 30 thus cut off were respectively placed to contact with and bonded to the electrolytic film 10 by thermocompression under the conditions of 125° C. and 10 kg/cm². Thereafter, the PTFE sheet was peeled off to obtain the CCM 25 constituted by a laminated body comprising the electrolytic film 10 which was held between the anode catalyst layer 20 and the cathode catalyst layer 30. The thickness of the CCM 25 was about 90 μm. The thickness of the anode catalyst layer 20 and of the cathode catalyst layer 30 was about 30 μm, respectively.

Then, a fuel control layer (not shown) and the anode MPL-attached GDL 110 were successively superimposed on the anode catalyst layer 20 of the CCM 25. As a material for the anode MPL-attached GDL 110, TGPH-120, 30 wt % Wetproofed; available from E-TEK Co., Ltd. (i.e., carbon paper TGPH-120 (Toray Industries, Ltd.) which was water repellent-treated by PTFE about 30 wt % in concentration) was employed. Further, on this anode MPL-attached GDL 110 was disposed a fuel supply means (not shown) for supplying a liquid fuel to this anode MPL-attached GDL 110.

Then, the cathode MPL 80 and the cathode GDL 90 were successively superimposed on the cathode catalyst layer 30 of the CCM 25. In this case, the MPL-attached cathode GDL was constituted by Elat GDL LT-2500-W (360 μm in thickness) (available from E-TEK Co., Ltd.). On this MPL-attached cathode GDL was disposed an oxidizing gas supply means (not shown) for supplying air as an oxidizing gas to the cathode GDL 90, thereby manufacturing the DMFC constructed as shown in FIG. 1.

The DMFC thus obtained was subjected to an electricity generation test. By fuel supply means, a fuel (aqueous methanol fuel) was supplied to the anode GDL at a concentration of 1.4 M and at a fuel supply rate of 0.7 cc/min. Further, by oxidizer supply means, air (oxidizer), 20.5% in oxygen concentration and 30% in humidity, was supplied from the cathode GDL, thereby actuating the fuel cell and assessing the cell characteristics such as the output voltage thereof. Incidentally, as the air supply rate, two kinds of flow rate, i.e., 60 and 35 cc/min were employed. This flow rate of 35 cc/min is one wherein water is liable to retain in the DMFC.

On this occasion, the temperature to be measured by temperature sensors (not shown) installed at the fuel supply means and at the oxidizer supply means was regulated to 60° C. by a temperature controller (not shown). The preliminary heating of air and fuel was not performed.

The results regarding the voltage characteristics at 150 mA/cm², which were obtained as each of the DMFCs was operated under the aforementioned conditions, are summarized in the following Table 5.

TABLE 5

Cell voltage (V)

| | 60 cc/min | 35 cc/min |
|---|---|---|
| Ex. II-1 | 0.49 | 0.47 |
| Ex. II-2 | 0.45 | 0.41 |
| Ex. II-3 | 0.46 | 0.42 |
| Ex. II-4 | 0.46 | 0.42 |
| Ex. II-5 | 0.48 | 0.46 |
| Ex. II-6 | 0.47 | 0.45 |
| Ex. II-7 | 0.46 | 0.42 |
| Comp. Ex. II-1 | 0.43 | 0.37 |
| Comp. Ex. II-2 | 0.44 | 0.37 |
| Comp. Ex. II-3 | 0.44 | 0.40 |

In the cathode catalyst layers of Examples, the pore ratio of 50 nm to 10 μm was 55% or more, the maximum pore ratio being as high as 80%. As a result, it is now possible to secure a high cell voltage irrespective of the air supply rate. The excellent results attained by these cathode catalyst layers of Examples can be attributed to the facts that all of them contained carbon fiber covered with a water repellent material and that the water repellent-covered carbon was included at a predetermined ratio. On the other hand, in the case of Comparative Example II-1 employing no water repellent material, the pore ratio was at most 48%.

The cathode catalyst layers of Comparative Example II-1 were constructed in the same manner as that of Example II-1 except that the carbon material was not subjected to the water repellent treatment. It will be apparently recognized from the comparison between Example II-1 and Comparative Example II-1 that if the water repellent treatment is not applied to carbon material, it would be impossible to enhance the pore ratio of 50 nm to 10 μm. In the case of Example II-1, the cell voltage at an air feeding rate of 60 cc/min was high and the degree of deterioration in cell voltage at low air feeding rates was restricted as compared with that of Comparative Example II-1.

The cathode catalyst layers of Comparative Example II-2 were constructed in the same manner as that of Example II-1 except that the content of the water repellent material-covered carbon material was made higher. Because of this large content of the water repellent material-covered carbon material, it was possible to increase the pore ratio of 50 nm to 10 μm. However, the cut-off of the network of protons or the deterioration of electron conductivity due to the insulating property of the water repellent material was caused to occur, thereby lowering the cell voltage. Especially, the lowering of cell voltage at low air feeding rates was found prominent.

With respect to Comparative Example II-3, it will be recognized that due to the small quantity of the water repellent material contained therein, it was impossible to obtain sufficient effects of the water repellent material, resulting in the lowering of cell voltage.

According to the embodiment of the present invention, it is possible to provide a DMFC which is equipped with a cathode catalyst layer exhibiting a sufficient gas network and a high proton conductivity. Further, according to the embodiment of the present invention, it is possible to provide a cathode for use in a DMFC which makes it possible to obtain a high activity even at low air feeding rates, and to provide a direct methanol fuel cell employing such a cathode.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cathode for a direct methanol fuel cell, which comprises a cathode catalyst layer comprising:
a first carbon powder supporting a noble metal catalyst;
a proton conductive polyelectrolyte at least partially covering a surface of the first carbon powder; and
a second carbon powder having a water repellent material on a surface thereof;
wherein the cathode catalyst layer is accompanied with a porous structure satisfying following conditions;
40%≦(V₁/V₀)≦70%
wherein V₀ represents a volume of pores having a diameter ranging from 3 nm to 10 μm; and V₁ represents a volume of pores having a diameter ranging from 50 nm to 10 μm.

2. The cathode according to claim 1, wherein 50% to 80% of the volume V₁ is occupied by pores constituted by the second carbon powder.

3. The cathode according to claim 1, wherein the second carbon powder is contained in the cathode catalyst layer at an amount of 1% to 10% based on a total weight of the cathode catalyst layer.

4. The cathode according to claim 1, wherein the water repellent material is contained in the cathode catalyst layer at an amount of 1% to 5% based on a total weight of the cathode catalyst layer.

5. The cathode according to claim 1, wherein at least a portion of the proton conductive polyelectrolyte is perfluorocarbon sulfonate.

6. The cathode according to claim 1, wherein the first carbon powder has an average particle diameter of 20-80 nm.

7. The cathode according to claim 1, wherein the water repellent material is selected from the group consisting of polytetrafluoroethylene, tetrafluoroethylene-perfluoroalkyl vinylether copolymer, tetrafluoroethylene-hexafluoropropylene copolymer, polychlorotrifluoroethylene, poly(vinylidene fluoride), poly(vinyl fluoride), tetrafluoroethylene-ethylene copolymer and amorphous fluororesin.

8. The cathode according to claim 1, wherein the second carbon powder is selected from the group consisting of high-electroconductive carbon black, furnace flack and acetylene black.

9. The cathode according to claim 1, wherein the second carbon powder has an average particle diameter of 20-80 nm.

10. A cathode for a direct methanol fuel cell, which comprises a cathode catalyst layer comprising:
carbon powder supporting a noble metal catalyst;
a proton conductive polyelectrolyte at least partially covering a surface of the carbon powder; and
a carbon material having a water repellent material on a surface thereof and incorporated into the cathode catalyst layer;
wherein:
an amount of the carbon material is 1-10% based on a total weight of the catalyst layer;
5 wt % or more of the carbon material is occupied by carbon fiber; and
the cathode catalyst layer is accompanied with a porous structure containing pores having a diameter ranging from 3 nm to 10 μm.

11. The cathode according to claim 10, wherein the water repellent material is contained in the cathode catalyst layer at an amount of 1% to 5% based on a total weight of the cathode catalyst layer.

12. The cathode according to claim 10, wherein the carbon fiber includes carbon fiber having an average particle diameter ranging from 50 nm to 1 μm and the porous structure satisfies the following conditions;
50%≦(V₁/V₀)≦90%
wherein V₀ represents a volume of pores having a diameter ranging from 3 nm to 10 μm; and V₁ represents a volume of pores having a diameter ranging from 50 nm to 10 μm.

13. The cathode according to claim 10, wherein 50% to 80% of the volume V₁ is occupied by pores constituted by constituted by the carbon material.

14. The cathode according to claim 10, wherein the water repellent material is selected from the group consisting of polytetrafluoroethylene, tetrafluoroethylene-perfluoroalkyl vinylether copolymer, tetrafluoroethylene-hexafluoropropylene copolymer, polychlorotrifluoroethylene, poly(vinylidene fluoride), poly(vinyl fluoride), tetrafluoroethylene-ethylene copolymer and amorphous fluororesin.

15. The cathode according to claim 10, wherein the carbon powder to be covered with the water repellent material contains powder formed of a material selected from the group consisting of high-electroconductive carbon black, furnace flack and acetylene black.

16. The cathode according to claim 15, wherein the powder has an average particle diameter of 20-80 nm.

17. The cathode according to claim 10, wherein the carbon fiber has a specific surface area of 150 m²/g or more.

18. The cathode according to claim 10, wherein the carbon fiber is contained at an amount of not more than 50 % based on a weight of the carbon material.

19. A direct methanol fuel cell comprising:
an anode;
the cathode claimed in claim 1; and
an electrolytic film sandwiched between the anode electrode and the cathode.

20. A direct methanol fuel cell comprising:
an anode;
the cathode claimed in claim 10; and
an electrolytic film sandwiched between the anode the cathode.
